(19) United States
(12) Patent Application Publication
(10) Pub. No.: US 2009/0113509 A1
(43) Pub. Date: Apr. 30, 2009

(54) VIDEO SYSTEM, VIDEO TRANSMITTER, VIDEO RECEIVER AND CONTROL METHOD FOR THE SAME

(75) Inventors: Yuan-Liang Tseng, Taipei City (TW); Hsueh-Shen Ling, Sijhih City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: AV TECH Corporation, Taipei County (TW)

(21) Appl. No.: 12/173,827

(22) Filed: Jul. 16, 2008

(30) Foreign Application Priority Data
Oct. 30, 2007 (TW) 96140805

(51) Int. Cl. H04N 7/173

(52) U.S. Cl. 725/118; 725/131

(57) ABSTRACT

A video system with a bi-directional transmission function is provided. The video system includes an video transmitter, a transmission interface and a video receiver. The video transmitter is coupled to the video receiver via the transmission interface (coaxial cable). The video transmitter is used for inserting a first control signal into the video signal according a synchronous signal of the video signal. The video transmitter is used for outputting the video signal with the first control signal to the video receiver via the transmission interface. The video receiver receives the video signal with the first control signal, and gets the first control signal from the video signal according to the synchronous signal of the video signal. In addition, the video receiver can insert a second control signal into the video signal and feedback the second control signal to the video transmitter via the transmission interface.

### CROSS-REFERENCE TO RELATED APPLICATION

This application claims the priority benefit of Taiwan application serial no. 96140805, filed on Oct. 30, 2007. The entirety of the above-mentioned patent application is hereby incorporated by reference herein and made a part of specification.

### BACKGROUND OF THE INVENTION

1. Field of the Invention

The present invention generally relates to a video system, and more particularly, to a video system with a bi-directional transmission function.

2. Description of Related Art

FIG. 1 is a block diagram illustrating a conventional video system. Referring to FIG. 1, the video system 100 includes a video camera 102, a video recorder 104, and a display 106. The video camera 102 (e.g. NTSC or PAL camera system) is used for capturing a object and generating a video signal. The video camera 102 outputted the video signal to the video recorder 104 through the coaxial cable 108. The video recorder 104 can store the video signal captured by the video camera 102, and the display 106 can display the video signal. The coaxial cable 108 is only used for transmitting video signal to video record 104.

In the conventional video system 100, video camera 102 and video record 104 both further comprises a RS-485 port. The video camera 102 connected the video recorder 104 through a RS-485 cable. The RS-485 cable 110 is in insertion required for the video camera 102 to transmit a control signal to the video recorder 104 or for the video recorder 104 to transmit a control signal to the video camera 102.

Furthermore, the conventional video camera 102 provides only a single direction transmission function. Furthermore, the video recorder 104 needs another RS-485 cable connected to the video recorder 104, if there is a need for the video recorder 104 to transmit a control signal to the video camera 102. Accordingly, cost of hardware is increased, and circuit layout is complex.

### SUMMARY OF THE INVENTION

Accordingly, the present invention is related to a video transmitter and a video receiver. The video transmitter is adapted for inserting a control signal into a video signal according to the synchronous signal of the video signal and then transmitting the video signal with the control signal to the video receiver through a coaxial cable. Meanwhile, the video receiver can also feedback a second control signal to the video transmitter through the coaxial cable.

The present invention further provides a control method for the video system having a bi-directional transmission function.

The present invention provides a video system having a bi-directional transmission function. The video system includes a video transmitter, a transmission interface and a video receiver. The video transmitter is adapted to output a video signal, and insert a first control signal into the video signal according to a synchronous signal of the video signal, and then transmit the video signal with the first control signal to the video receiver via the transmission interface. In this manner, the video receiver receives the video signal with the first control signal through the transmission interface, and obtains the first control signal from the video signal. Furthermore, the video receiver is adapted to feedback a second control signal to the video transmitter through the transmission interface.

The present invention provides an video transmitter capable of transmitting a video signal with a control signal. The video transmitter includes a video capture module, a first synchronizing separator circuit, a mixing circuit, a first control unit, and a signal receiver. The video capture module is used for generating a video signal. The first control unit is coupled to the first synchronizing separator circuit and the mixing circuit respectively. The first synchronizing separator circuit is adapted to receive the video signal, of the video signal. Then, the first synchronizing separator circuit transmit the synchronous signal of the video signal to the first control unit. In such a way, the first control unit is capable of counting the synchronous signal of the video signal and generating a counting value. When the counting value matches to a pre-set value, the first control unit enables the mixing circuit to mix the first control signal into the video signal. Then first control unit transmits the video signal with the first control signal to the transmission interface.

The present invention further provides a video receiver, including a second synchronizing separator circuit, a variable resistors circuit, a second control unit, and a processing unit. Similarly, the second control unit is coupled to the second synchronizing separator circuit and the variable resistors circuit respectively. The second synchronizing separator circuit is adapted to receive the video signal with the first control signal from the transmission interface, and get the synchronous signal of the video signal and transmit the first control signal to the second control unit. The variable resistors circuit is coupled to the transmission interface. Therefore, the second control unit is adapted to adjust the impedance value of the variable resistors circuit according to the synchronous signal of the video signal, so as to transmit a second control signal to the video transmitter via the transmission interface. In insertion, the processing unit is coupled to the control unit for receiving and processing the control signal.

The present invention further provides a control method for a video system. The control method includes: receiving a video signal, and getting a synchronous signal of the video signal; counting the synchronous signal, and obtaining a first counting value; and inserting a first control signal into the video signal when the first counting value matches to a first pre-set value, and the transmitting terminal transmits the video signal with the first control signal to a receiving terminal via a transmission interface.

Correspondingly, in the control method, the receiving terminal gets the synchronous signal of the video signal in which the first control signal was receiving the video signal via the transmission interface. Next, counting the synchronous signal and obtaining a second counting value.

According the present invention, the step of outputting the second control signal further includes adjusting an impedance value of the variable resistors circuit when the second control signal to be outputted has a program code of 1; and adjusting the impedance value of the variable resistors circuit when the second control signal to be outputted has a program code of 0.

According to the present invention, the synchronous signal of the video signal can be either a horizontal synchronous signal of the video signal, or a vertical synchronous signal of the video signal.

According to the present invention, the transmission interface for connecting the transmitting terminal and the receiving terminal is a coaxial-cable or a RCA cable.

The present invention is proposed inserting the control signal into the video signal and transmitting the video signal with the control signal through a coaxial-cable, and thereby eliminate the need of an transmission terminal (ex: RS-232 cable) for transmitting the control signal. In such a way, the cost of the hardware can be reduced and the circuit layout can be simplified. In the other hand, the present invention proposes transmitting the control signal by adjusting the impedance values of the transmission interface to achieve a bi-directional transmission function through a coaxial-cable.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram illustrating a conventional video system.

FIG. 2 is a block diagram illustrating a video system according to an embodiment of the present invention.

FIG. 3 is a circuit block diagram illustrating an transmitter terminal according to an embodiment of the present invention.

FIG. 4 is a flow chart showing steps a method for generating a video signal with a control signal according to an embodiment of the present invention.

FIG. 5 is a signal clock sequence diagram of an video transmitter according to an embodiment of the present invention.

FIG. 6 is a circuit block diagram illustrating a video receiver according to an embodiment of the present invention.

FIG. 7 is a flow chart illustrating a control method for a video system according to an embodiment of the present invention.

FIG. 8 illustrates an equivalent circuit diagram of the video system as shown in FIG. 2.

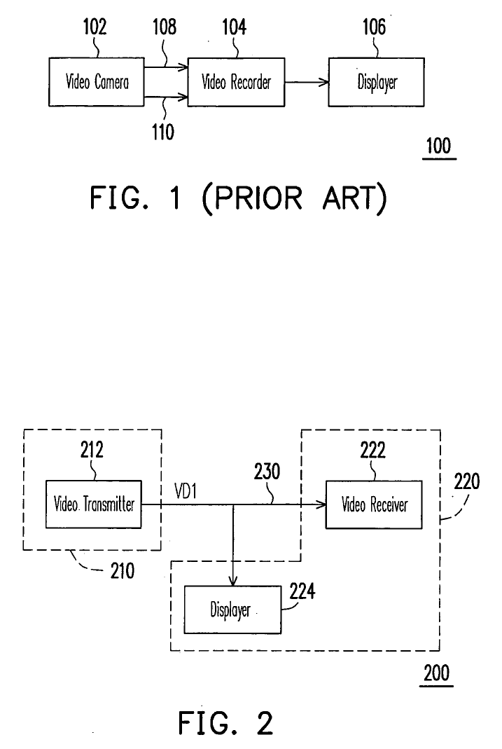

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

FIG. 2 is a block diagram illustrating a video system according to an embodiment of the present invention. Referring to FIG. 2, the video system 200 includes an transmitting terminal 210, and a receiving terminal 220. The transmitting terminal 210 and the receiving terminal 220 are coupled one to another via a transmission interface 230. According to an aspect of the embodiment, the transmission interface 230 is a coaxial cable.

The transmitting terminal 210 includes an video transmitter 212 (e.g. NTSC or PAL camera system). The transmitting terminal 210 is adapted for transmitting a video signal VD1 with a control signal to the receiving terminal 220 via the transmission interface 230. The transmission interface 230 for example, can be a coaxial cable or a RCA cable for connecting the transmitting terminal 210 and the receiving terminal 220. The receiving terminal 220 includes a video receiver 222 and a display 224. The video receiver 222, for example, is a digital video recorder (DVR), employed for receiving the video signal VD1 with a control signal c1 from video transmitter 212 via the transmission interface 230, and act in response to the control signal. Further, the display 224, for example, can be a liquid crystal display (LCD) employed for receiving the video signal VD1 and displaying the same for the user to view.

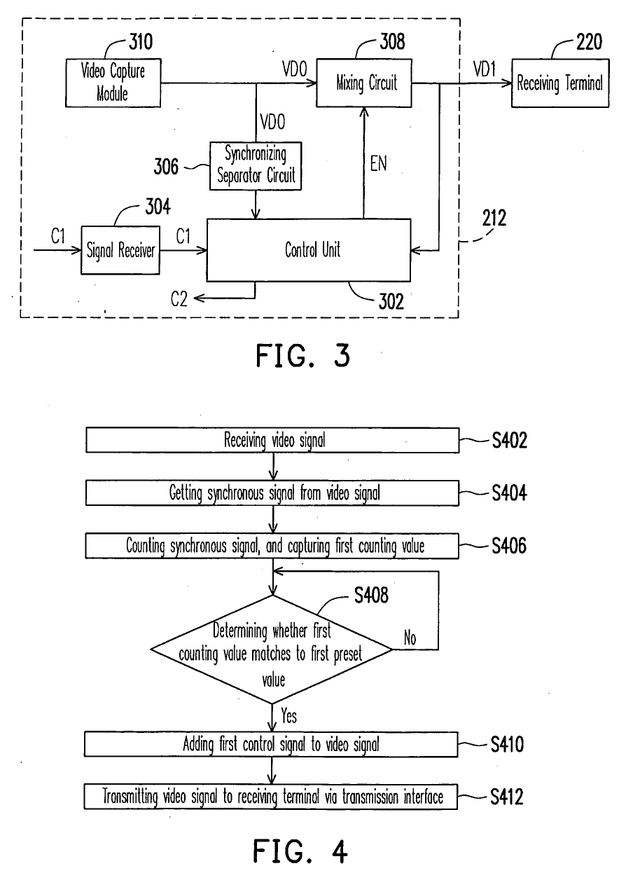

FIG. 3 is a circuit block diagram illustrating an video transmitter according to an embodiment of the present invention. Referring to FIG. 3, the video transmitter 212 includes a control unit 302, a signal receiver 304, a synchronizing separator circuit 306, and a mixing circuit 308. The control unit 302 is coupled to the signal receiver 304, the synchronizing separator circuit 306 and the mixing circuit 308, respectively. The mixing circuit 308 is coupled to the receiving terminal 230 via the transmission interface 230. A video signal VD0 can be transmitted via the transmission interface 230 from the transmitting terminal 210 to the receiving terminal 220.

According to an embodiment of the invention, the video transmitter 212 further includes an video capture module 310 for capturing the video signal VD0. In other embodiments, the original video signal VD0 may be outputted from an external image acquisition apparatus.

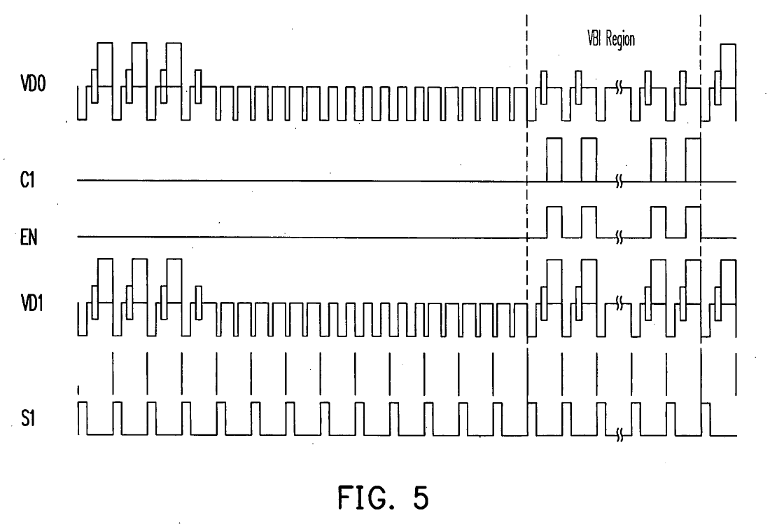

FIG. 4 is a flow chart showing steps of a method for generating a video signal with a control signal inserted according to an embodiment of the present invention. FIG. 5 is a signal clock sequence diagram of an video transmitter according to an embodiment of the present invention. Referring to FIGS. 3, 4, and 5 together, in the video transmitter 212, the signal receiver 304 receives a first control signal C1, and transmits the first control signal C1 to the control unit 302. As shown in FIG. 4, at step S402, the synchronizing separator circuit 306 receives an original video signal VD0, and then at step S404, the synchronizing separator circuit 306 gets a synchronous signal S1 of the original video signal VD0, and transmits the synchronous signal S1 to the control unit 302. According to an aspect of the embodiment, the synchronous signal S1 of the original video signal VD0 is a horizontal synchronous signal of the original video signal. However, in other embodiments, the synchronous signal S1 may be a vertical synchronous signal of the original video signal, or a combination of a horizontal synchronous signal and a vertical synchronous signal.

At step S406, when the control unit 302 receives the synchronous signal S1 outputted from the synchronizing separator circuit 306, the synchronous signal S1 is counted, and a first counting value is obtained thereby. At step S408, the control unit 302 determines whether the first counting value matches a first pre-set value. If the first counting value is determined to be lower than the first pre-set value, i.e., denoted as “No” in the step S408, the synchronous signal S1 is continuously counted until the control unit 302 determines that the first counting value equals to the first pre-set value, i.e., denoted as “Yes” in the step S408. When the first counting value is determined to be equal to the first pre-set value, an enabling signal EN is transmitted to the mixing circuit 308. Next, at step S410, the mixing circuit 308 inserts the first control signal C1 into the video signal VD0 to generate a new video signal VD1. When the mixing circuit 308 generates the new video signal VD1, the mixing circuit 308 at step S412 transmits the new video signal VD1 to the receiving terminal 220 via the transmission interface 230.

Taking FIG. 5 as an example, in the present embodiment, the first pre-set value is, for example, 10. That is, when it is determined that the first counting value equals to 10, the control unit 302 outputs the enabling signal EN to the mixing circuit 308. The mixing circuit 308 then inserts the first control signal C1 into the original video signal VD0 until the first counting value reaches 21. In such a way, the mixing circuit 308 outputs the new video signal VD1 for transmission. Further, in the present embodiment, the first control signal C1 is inserted into the original video signal VD0, for example, at a position, such as a VB1 region. In this manner, the application of the current embodiment would not affect video qualities of the original video signal VD0. However, one of ordinary skill in the art would understand that the position where the first control signal C1 is inserted into the video signal VD0 is not limited in the present invention.

Although as shown above, the method illustrated in FIG. 4 is applicable for an video transmitter, those having ordinary skill in the art would understand that the method is also applicable for the receiving terminal 220, especially for the display 224. A structure of the video receiver 222 adapted to transmit a control signal to the transmitting terminal 210 may be discussed in more details as following.

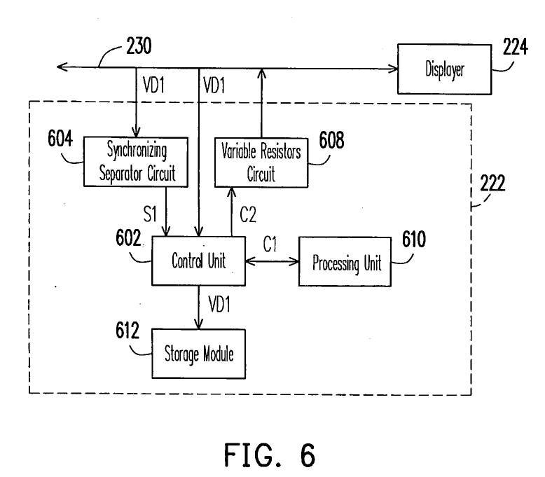

FIG. 6 is a circuit block diagram illustrating a video receiver according to an embodiment of the present invention. Referring to FIG. 6, after being outputted from the video transmitter 212, the video signal VD1 can be transmitted to the receiving terminal 220 via the transmission interface 230, and then be received by the video receiver 222 and the display 224. The video receiver 222 includes a control unit 602, a synchronizing separator circuit 604, a variable resistors circuit 608, a processing unit 610, and a storage module 612. The control unit 602 is coupled to the synchronizing separator circuit 604, the variable resistors circuit 608, the processing unit 610, and the storage module 612 respectively, and is also coupled to the transmission interface 230. According to an embodiment of the present invention, the storage module 612 comprises a hard disk.

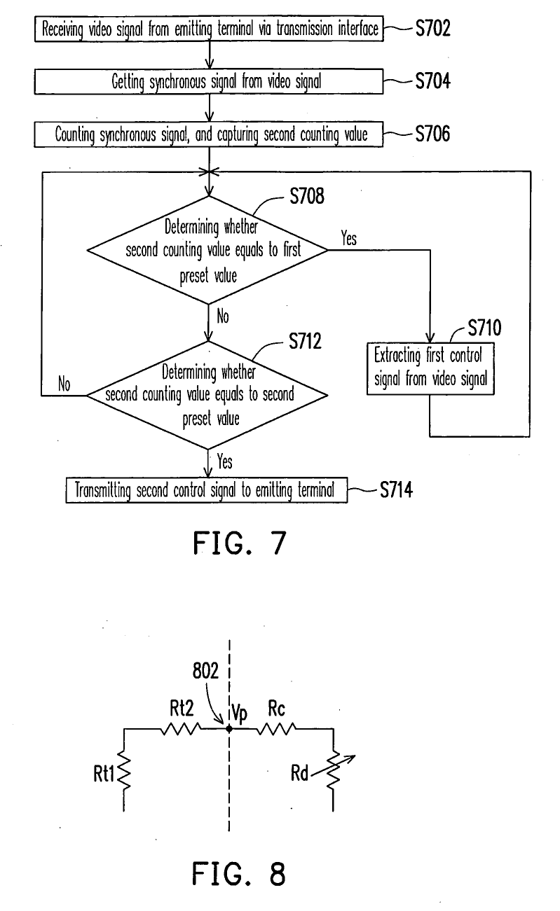

FIG. 7 is a flow chart illustrating a control method for a video system according to an embodiment of the present invention. Referring to FIGS. 6 and 7 together, when the video transmitter 212 transmits the video signal VD1 via the transmission interface 230, at step S702, the control unit 602 and the synchronizing separator circuit 604 receives the video signal VD1. Next, at step S704, the synchronizing separator circuit 604 gets the synchronous signal S1 of the video signal VD1 and provides to the control unit 602. Consequently, at step S706, the control unit 602 counts the synchronous signal S1, and obtains a second counting value.

Next, at step S708, the control unit 602 determines whether the second counting value equals to the first pre-set value. If the second counting value does not reach the first pre-set value, i.e., denoted by “No” in step S708, then procedure proceeds to step S712, to determine whether or not the second counting value equals to a second pre-set value. If the control unit 602 determines that the second counting value is neither equal to the first pre-set value, nor equal to the second pre-set value, then the control unit 602 repeats the step S708 and continues to count the synchronous signal S1 and generates a new second counting value.

Correspondingly, if the control unit 602 determines during the step S708 that the second counting value equals to the first pre-set value, i.e., denoted by “Yes” in step S708, the control unit 602, at step S 710, extracts the first control signal C1 from the video signal VD1, and transmits the first control signal C1 to the processing unit 610, so that the processing unit 610 acts according to the first control signal C1. Further, the control unit 602 can store the video signal VD1 in the storage module 612. Next, the control unit 602 can further repeat step S708, to continue counting the synchronous signal S1, and obtain a new second counting value.

Furthermore, if the control unit 602 determines during the step S712 that the second counting value equals to the second pre-set value, i.e., denoted by “Yes” in step S712, the processing unit 610 makes the control unit 602 to output a second control signal C2. The second control signal C2, at step S714, is transmitted to the transmitting terminal 210 via the transmission interface 230.

Although the above embodiments are illustrated which are applicable for the video receiver 222, those of ordinary skill in the art would be aware that when the transmitting terminal 210 receives the second control signal C2 outputted from the receiving terminal 220, the video transmitter 212 is also capable of retrieving the second control signal C2 in a manner described above. As such, in the following embodiments, the video receiver 222 employs another approach to transmit the second control signal C2, that is, the control unit 602 controls and adjusts an impedance value of the variable resistors circuit 608 for transmitting the second control signal to the video transmitting.

FIG. 8 illustrates an equivalent circuit diagram of the video system as shown in FIG. 2. Referring to FIGS. 3, 6, and 8, in the equivalent circuit, resistors Rt1 and Rt2 represent an equivalent impedance of the transmission interface 230. Resistor Rc represents an equivalent impedance of the transmission interface 230. In the present embodiment, an impedance value Rc of an inside of the coaxial cable is about 75 ohm. Further, the resistor Rd represents an equivalent impedance of the receiving terminal 220. Because the impedance value of the variable resistors circuit 608 of the video receiver 222 is variable, the resistor Rd can be equated by a variable resistor.

It can be clearly identified from FIG. 8 that resistors Rt1, Rt2, Rc and variable resistor Rd can be connected in series, so that a voltage value Vp can be obtained at a node 802, which is obtained via a voltage division with the serially connected resistors Rc and Rd, in which Rc is the internal impedance value of the coaxial cable. One of ordinary skill in the art would understand that the component voltage value Vp is determined by the resistance of the resistor Rd. As such, when the control unit 602 of the video receiver 222 intends to transmit the second control signal C2, it can determine the impedance value of the variable resistors circuit 608 according to the status of the second control signal C2 to be transmitted.

In more details, when the video receiver 222 needs to transmit a second control signal C2 having a program code of 1, the control unit 602 adjusts the impedance value of the variable resistors circuit 608. At this time, a status of the voltage value (Vp) was maintained at a first level. Therefore, when the control unit 302 of the video transmitter 212 detects that the voltage value (Vp) is at the first level, the control unit 302 then outputs a second control signal C2 having the program code of 1. otherwise, when the video receiver 222 needs to transmit a second control signal C2 having a program code of 0, the control unit adjusts the impedance value Rd of the variable resistors circuit 608, so as to the voltage (Vp) from the first level to the second level. When the control unit 302 detects the voltage value Vp is at the second level, the control unit 302 then outputs the second control signal C2 having the program code of 0.

It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims and their equivalents.

What is claimed is:

1. An video transmitter, for transmitting a video signal with a control signal, comprising:
an video capture module, for capturing a video signal;
a synchronizing separator circuit, for receiving the video signal, and getting a synchronous signal of the video signal;
a mixing circuit, coupled to a transmission interface, the mixing circuit receiving the video signal from the synchronizing separator circuit;
a control unit, coupled to the synchronizing separator circuit and the mixing circuit, for counting the synchronous signal, and generating a counting number; and
a signal receiver, coupled to the control unit, for receiving a control signal, and transmitting the control signal to the control unit;
Wherein the counting number matches a pre-set number, the control unit transmits the control signal to the mixing circuit, the mixing circuit insert the control signal into the video signal, and transmits the video signal with the control signal to the transmission interface.

2. The video transmitter according to claim 1, wherein the synchronous signal comprises a horizontal synchronous signal of the video signal or a vertical synchronous signal of the video signal.

3. The video transmitter according to claim 1, wherein the transmissions interface comprises a coaxial cable.

4. A video receiver, for receiving a video signal with a control signal via a transmission interface, comprising:
a synchronizing separator circuit, for receiving the video signal with a control signal through the transmission interface, and getting a synchronous signal of the video signal;
a variable resistors circuit, coupled to the transmission interface;
a control unit, coupled to the synchronizing separator circuit and the Variable Resistors circuit, for adjusting an impedance values of the Variable Resistors circuit according to the synchronous signal of the video signal; and
a processing unit coupled to the control unit, for receiving and processing the control signal.

5. The video receiver according to claim 4, wherein the video receiver further comprises a storage module coupled to the control unit for storing the video signal.

6. The video receiver according to claim 4, wherein the synchronous signal comprises a horizontal synchronous signal of the video signal or a vertical synchronous signal of the video signal.

7. The video transmitter according to claim 4, wherein the transmissions interface comprises a coaxial cable.

8. A video system having a bi-directional transmission function, comprising:
an video transmitter, for inserting a first control signal into the video signal, according to a synchronous signal of the video signal, and outputting the video signal with the first control signal;
a transmission interface, coupled to the video transmitter, for transmitting the video signal with the first control signal; and
a video receiver, coupled to the transmission interface, for receiving the video signal, and getting the first control signal from the video signal according to the synchronous signal of the video signal, and adjusting an impedance values of the transmission interface for feeding back a second control signal to the video transmitter.

9. The video system according to claim 8, further comprising a display coupled to the transmission interface for displaying the video signal.

10. The video system according to claim 8, wherein the video transmitter comprises:
an video capture module, for capturing a video signal;
a synchronizing separator circuit, for receiving the video signal, and getting a synchronous signal of the video signal;
a mixing circuit, coupled to a transmission interface, the mixing circuit receiving the video signal from the synchronizing separator circuit;
a first control unit, coupled to the first synchronizing separator circuit and the mixing circuit, for counting the synchronous signal, and generating a counting number; and
a signal receiver, coupled to the control unit, for receiving a control signal, and transmitting the control signal to the control unit;
Wherein the counting number matches a pre-set number, the control unit transmits the control signal to the mixing circuit, the mixing circuit inserts the control signal into the video signal, and transmits the video signal with the control signal to the transmission interface.

11. The video system according to claim 8, wherein the video receiver comprises:
a second synchronizing separator circuit, for receiving the video signal with a control signal from the transmission interface, and getting a synchronous signal of the video signal;
a Variable Resistors circuit, coupled to the transmission interface; and
a second control unit, coupled to the second synchronizing separator circuit and the Variable Resistors circuit, for adjusting an values of the Variable Resistors circuit according to the synchronous signal; and
a processing unit coupled to the control unit, for receiving and processing the control signal.

12. The video system according to claim 8, wherein the synchronous signal comprises a horizontal synchronous signal or a vertical synchronous signal.

13. The video system according to claim 8, wherein the transmission interface comprises a coaxial cable.

14. A control method for a video system, the video system comprising an transmitting terminal and a receiving terminal, the control method comprising:
receiving a video signal;
getting a synchronous signal of the video signal;
counting the synchronous signal, and generating a first counting number; and
inserting a first control signal into the video signal;
when the first counting number matches a first pre-set number, transmitting the video signal with the first control signal from the transmitting terminal to the receiving terminal via a transmission interface.

15. The control method according to claim 14, further comprising:
getting the synchronous signal when the receiving terminal receives the video signal from the transmitting terminal via the transmission interface;
counting the synchronous signal, and generating a second counting number;
determining whether the second counting number matches the first pre-set number;
getting the first control signal from the video signal when the second counting number matches the first pre-set number;
determining whether the second counting number matches a second pre-set number; and
transmitting a second control signal from the receiving terminal to the transmitting terminal when the second counting number matches the second pre-set number.

16. The control method according to claim 15, wherein the step of transmitting the second control signal comprises:
maintaining the resistor values of the transmission interface when the second control signal to be outputted has a program code is 1; and
adjusting the resistor values of the transmission interface when the second control signal to be outputted has a program code is 0.

17. The control method according to claim 14, wherein the synchronous signal comprises a horizontal synchronous signal or a vertical synchronous signal of the video signal.
